(19) United States
(12) Patent Application Publication
(10) Pub. No.: US 2019/0390605 A1
(43) Pub. Date: Dec. 26, 2019

(54) GAS TURBINE ENGINE SPOOL

(71) Applicant: ROLLS-ROYCE plc, London (GB)

(72) Inventor: Crispin D BOLGAR, Nottingham (GB)

(73) Assignee: ROLLS-ROYCE plc, London (GB)

(21) Appl. No.: 16/439,878

(22) Filed: Jun. 13, 2019

(30) Foreign Application Priority Data
Jun. 26, 2018 (GB) 1810435.6

(51) Int. Cl. F02C 7/36; F02C 3/06; F04D 29/054

(52) U.S. Cl. CPC F02C 7/36; F05D 2260/40; F04D 29/054; F02C 3/06

(57) ABSTRACT

A spool of a gas turbine engine includes: a compressor having one or more compressor stages; a turbine having one or more turbine stages; and a core shaft joining the compressor to the turbine. The core shaft includes a bolted joint which connects a compressor end portion of the core shaft to a turbine end portion of the core shaft by a circumferential row of fastening bolts. The spool further includes a tie bar which extends through the core shaft to tie the compressor to the turbine.

This disclosure claims the benefit of UK Patent Application No. GB 1810435.6, filed on 26 Jun. 2019, which is hereby incorporated herein in its entirety.

The present disclosure relates to a joint between a turbine and a compressor of a gas turbine engine.

It is conventional to locate the high pressure spool of an aerospace gas turbine with a ball bearing at the front of the spool. These bearings have finite load capacity, so gas path and air system features are designed to keep the bearing load within appropriate levels. However, the pressure rise in a compressor produces a significant forwards load which is generally hard to manipulate to any significant extent. It is therefore standard practice to manage bearing load by positioning seals on the high pressure turbine to provide loads to offset the compressor load. High pressure ratio compressors (especially in applications with high exit pressures which are typical in the operational cycles of large engines) produce a significant forward end load and require a significant offsetting rearward end load from the turbine.

The turbine and compressor of a spool are connected by a core shaft which transmits drive from the turbine to the compressor. As the turbine and compressor are manufactured as separate components, one approach for physically coupling the turbine and compressor is to provide a bolted joint at this location. However, significant end loads can place high demands on such a joint. Moving the position of the bolted joint to a higher radius can provide increased capability to withstand such loads, but this places significant constraints on turbine air system and coverplate designs, which in turn impacts unfavourably on engine thermal management.

Another approach for physically coupling the turbine and compressor is to use a tie bar which extends through the core shaft. However, in order for the tie bar to transfer torque, features such as splines, dogs or curvic teeth are needed. These add cost and present a fatigue life challenge.

It would be desirable to provide an approach for joining the turbine and compressor which addresses the above problems.

According to a first aspect there is provided a spool of a gas turbine engine, the spool including:
a compressor at a forward end of the spool and having one or more compressor stages;
a turbine at a forward end of the spool and having one or more turbine stages; and
a core shaft joining the compressor to the turbine;
wherein the core shaft includes a bolted joint which connects a compressor end portion of the core shaft to a turbine end portion of the core shaft by a circumferential row of fastening bolts; and
wherein the spool further includes a tie bar which extends through the core shaft to tie the compressor to the turbine.

Thus the tie bar provides a secondary load path in addition to the bolted joint. Advantageously, the tie bar can relieve the bolted joint from sole responsibility for accommodating the end loads, while the bolted joint can relieve the tie bar from a need to transmit torque. That is, responsibilities for torque-transmission and end load carrying can be divided between the bolted joint and the tie bar respectively. In this way, a higher radius for the bolted joint and torque-transmitting features for the tie bar can both be avoided while still providing a high end load capacity and sufficient torque carrying capacity.

According to a second aspect there is provided a gas turbine engine for an aircraft comprising:

an engine core having the spool of the first aspect, the spool being a first spool, the turbine being a first turbine, the compressor being a first compressor, and the core shaft being a first core shaft, and the engine core further having a second spool including a second turbine, a second compressor, and a second core shaft connecting the second turbine to the second compressor;

wherein the first spool is arranged to rotate at a higher rotational speed than the second spool.

The gas turbine engine may further comprise:
a fan located upstream of the engine core, the fan comprising a plurality of fan blades; and
a gearbox that receives an input from the second core shaft and outputs drive to the fan so as to drive the fan at a lower rotational speed than the second core shaft

Optional features of the present disclosure will now be set out. These are applicable singly or in any combination with any aspect of the present disclosure.

Conveniently, the bolted joint can comprise a first disc provided by the compressor end portion of the core shaft and a second disc provided by the turbine end portion of the core shaft, the first and second discs being clamped together by the row of fastening bolts.

The tie bar can take the form of a hollow shaft. Particularly in the case of a multi-spool engine with nested spools, this can allow the core shaft of one spool to extend through the tie bar of another spool.

One of the joints may be formed by a stop formation at one end of the tie bar which abuts a corresponding stop formation provided by one of the compressor and the turbine, and the other joint may be formed by a threaded ring carried at the other end of the tie bar which screws onto corresponding threads provided by the other of the compressor and the turbine to urge the stop formations against each other and thereby tension the tie bar. This arrangement allows the tie bar to be pre-loaded. For example, the corresponding stop formation may be provided by the compressor and the corresponding threads may be provided by the turbine.

Conveniently, the joint with the compressor may be formed rearward of the one or more compressor stages, for example at an extension of a rear cone of the compressor. Another option, however, is to form the joint with the compressor forward of the one or more compressor stages, for example adjacent a front stub shaft of the compressor, such a stub shaft typically being provided to carry a bevel gear that drives a radial shaft for an accessory drive.

Conveniently, the joint with the turbine may be formed rearward of the one or more turbine stages, for example at a seal-carrying rear extension from a rearmost rotor disc of the turbine.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from a core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. As set out in the second aspect above, the engine core may further comprise a second turbine, a second compressor, and a second core shaft connecting the second turbine to the second compressor. The first turbine, first compressor, and first core shaft may be arranged to rotate at a higher rotational speed than the second core shaft.

In such an arrangement, the first compressor may be positioned axially downstream of the second compressor. The first compressor may be arranged to receive (for example directly receive, for example via a generally annular duct) flow from the second compressor.

The gearbox may be arranged to be driven by the core shaft that is configured to rotate (for example in use) at the lowest rotational speed (for example the second core shaft in the example above). For example, the gearbox may be arranged to be driven only by the core shaft that is configured to rotate (for example in use) at the lowest rotational speed (for example only be the second core shaft, and not the first core shaft, in the example above).

Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the first compressor. By way of further example, the flow at the exit to the combustor may be provided to the inlet of the first turbine. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position, The ratio of the radius of the fan blade at the hub to the radius of the fan blade at the tip may be less than (or on the order of) any of: 0.4, 0.39, 0.38 0,37, 0.36, 0.35, 0,34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity U. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17.

The bypass ratio may be in an inclusive range bounded by any two of the values in the previous sentence (i.e. the values may form upper or lower bounds). The bypass duct may be substantially annular, The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high, This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K, The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds), The maximum TET may occur, for example, at a high thrust condition, for example at a maximum take-off (MTO) condition,

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc), Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or ding. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0,76 to 0.84, for example 0.77 to 0,83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa: and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

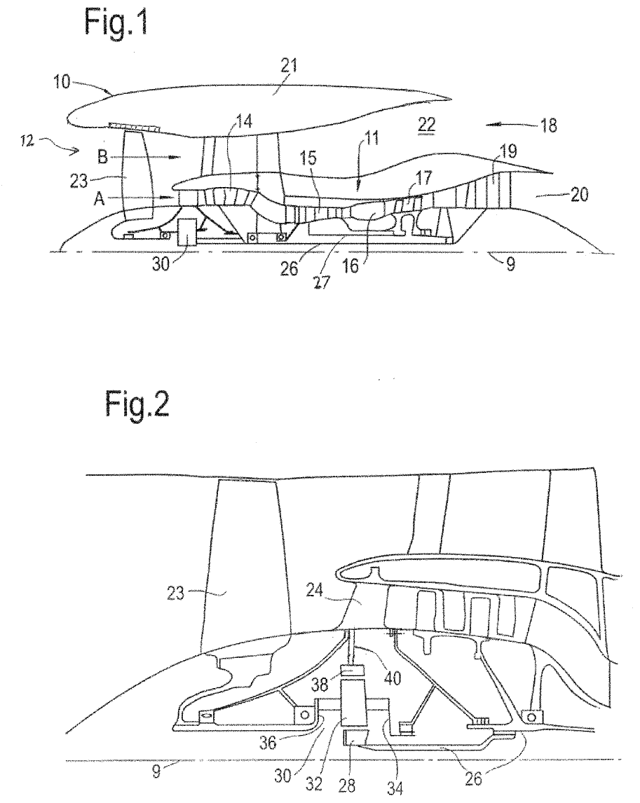

FIG. 1 is a sectional side view of a gas turbine engine;

FIG. 2 is a close up sectional side view of an upstream portion of a gas turbine engine,

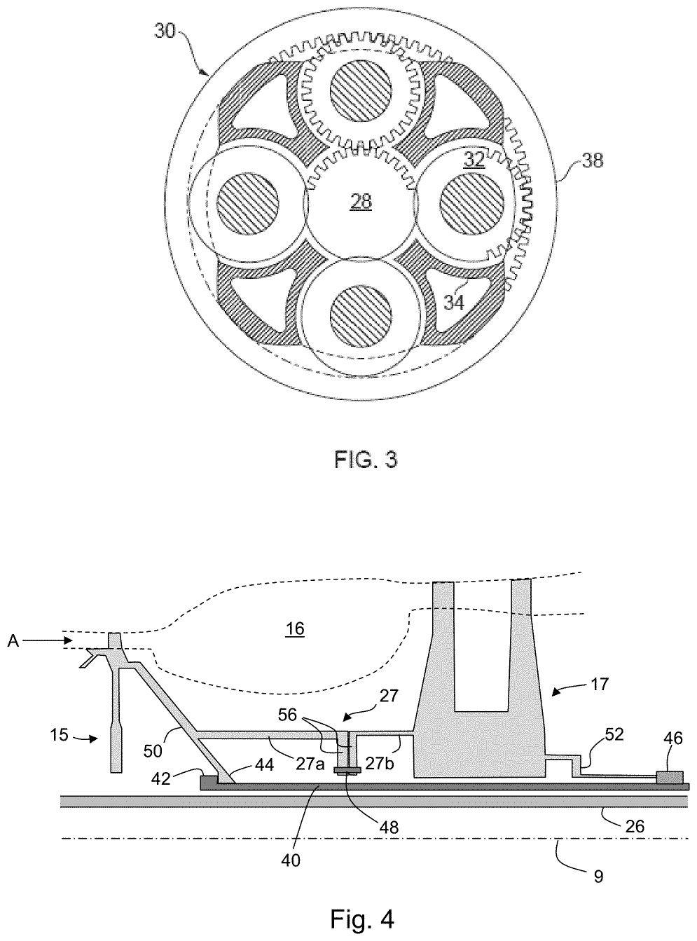

FIG. 3 is a partially cutaway view of a gearbox for a gas turbine engine;

FIG. 4 is a schematic close up sectional side view of part of a high pressure spool of a gas turbine engine; and

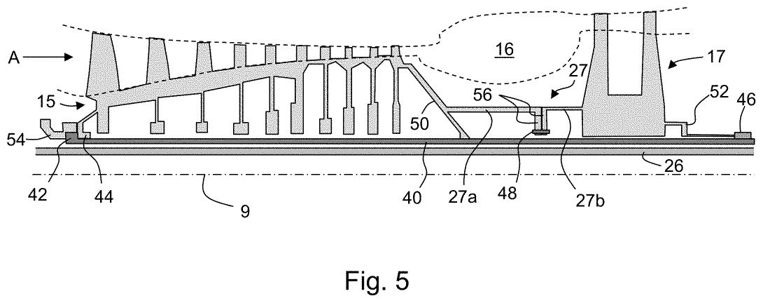

FIG. 5 is schematic close up sectional side view of a variant of the high pressure spool of FIG. 4.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, combustion equipment 16, a high pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a core shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable core shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the core shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of core shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view), The axial, radial and circumferential directions are mutually perpendicular.

FIG. 4 is a schematic close up sectional side view of part of a high pressure spool of a gas turbine engine. Features of the engine corresponding to features of the engines shown in FIGS. 1 and 2 are indicated with the same reference numbers in FIG. 4 as are used in FIGS. 1 and 2. The inner and outer boundaries of the working gas annulus for the core airflow A are indicated by dashed lines.

The high pressure spool comprises a multi-stage high pressure compressor 15 (only the last stage being shown in FIG. 4), a two-stage high pressure turbine 17, and a core shaft 27 joining the compressor to the turbine, the core shaft having a compressor end portion 27a and a turbine end portion 27b.

The compressor 27a and turbine 27b end portions of the core shaft 27 are connected by a bolted joint formed by a circumferential row of fastening bolts 48 which clamp together a pair of minidiscs 56 respectively provided by the end portions of the core shaft. This joint is the primary load path for the transmission of torque between the turbine 17 and the compressor 15.

Also connecting the turbine 17 and the compressor 15 is a tie bar 40. This extends through the high pressure core shaft 27, and is itself formed as a hollow shaft so that the low pressure core shaft 26 can in turn extend through it. The tie bar relieves the bolted joint of sole responsibility for transmitting a high forward end load caused by a high pressure ratio acting across the compressor onto seals acting on the turbine where a rearward end load is produced to balance the forward end load. In this way, the bolted joint does not need to be configured and positioned (e.g. at high radii where it may conflict with engine air system and coverplate designs) to provide a load-carrying capability sufficient to carry the full magnitude of the end loads. Similarly, as primary responsibility for torque-transmission remains with the bolted joint, the tie bar does not need require special torque-transmitting features, such as splines, dogs or curvic teeth.

Thus, conveniently, the joint between the compressor end of the tie bar 40 and the compressor 15 can be formed by a simple stop formation 42 at the end of the tie bar which abuts a corresponding stop formation 44 formed, for example, by an extension of a rear cone 50 of the compressor. The joint between the turbine end of the tie bar 40 and the turbine 17 can be formed by a threaded ring 46 carried by the tie bar and screwed onto a corresponding thread provided, for example, on a seal-carrying extension 52 from the rear of a rearmost rotor disc of the turbine. This arrangement allows the tie bar to be pre-loaded.

However, other positions for these joints are possible. FIG. 5 shows, for example, a schematic close up sectional side view of a variant of the high pressure spool of FIG. 4. In this variant, the joint between the compressor end of the tie bar 40 and the compressor 15 is again formed by respective abutting stop formations 42, 44, but the tie bar extends the entire length of the compressor, and the stop formation 44 is provided forward of the of the compressor stages adjacent a stub shaft 54 carrying a bevel gear that drives a radial shaft for an accessory drive.

In general, wherever the joints are located on the compressor 15 and turbine 17, they should be relatively stiff parts of the respective component.

In summary, the combination of the bolted joint and tie bar 40 relative to an arrangement for connecting the compressor 15 and turbine 17 which has only one of these, can reduce manufacturing costs, avoid torque-transmitting features which may be vulnerable to fatigue, and has advantages in relation to space utilisation. The combination is particularly beneficial in the context of a large engine in which a high pressure ratio acts across the compressor. It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A spool of a gas turbine engine, the spool including:
a compressor at a forward end of the spool and having one or more compressor stages;
a turbine at a rearward end of the spool and having one or more turbine stages; and
a core shaft joining the compressor to the turbine;
wherein the core shaft includes a bolted joint which connects a compressor end portion of the core shaft to a turbine end portion of the core shaft by a circumferential row of fastening bolts; and
wherein the spool further includes a tie bar which extends through the core shaft to form a joint with the compressor and a joint with turbine thereby tying the compressor to the turbine.

2. The spool according to claim 1, wherein one of the joints is formed by a stop formation at one end of the tie bar which abuts a corresponding stop formation provided by one of the compressor and the turbine, and the other joint is formed by a threaded ring carried at the other end of the tie bar which screws onto corresponding threads provided by the other of the compressor and the turbine to urge the stop formations against each other and thereby tension the tie bar.

3. The spool according to claim 1, wherein the joint with the compressor is formed rearward of the one or more compressor stages.

4. The spool according to claim 1, wherein the joint with the compressor is formed forward of the of the one or more compressor stages.

5. The spool according to claim 1, wherein the joint with the turbine is formed rearward of the one or more turbine stages.

6. A gas turbine engine for an aircraft comprising:
an engine core having the spool of claim 1, the spool being a first spool, the turbine being a first turbine, the compressor being a first compressor, and the core shaft being a first core shaft, and the engine core further having a second spool including a second turbine, a second compressor, and a second core shaft connecting the second turbine to the second compressor;
wherein the first spool is arranged to rotate at a higher rotational speed than the second spool.

7. The gas turbine engine according to claim 6, further comprising:
a fan located upstream of the engine core, the fan comprising a plurality of fan blades; and
a gearbox that receives an input from the second core shaft and outputs drive to the fan so as to drive the fan at a lower rotational speed than the second core shaft.
